(19) United States
(12) Patent Application Publication
(10) Pub. No.: US 2008/0115056 A1
(43) Pub. Date: May 15, 2008

(54) Providing calculations within a text editor

(75) Inventors: Daniel Escapa, Redmond, WA (US); Owen Braun, Seattle, WA (US); Peter Baer, Duvall, WA (US); Brian Holley, Bellevue, WA (US); Chris Pratley, Seattle, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/599,108

(22) Filed: Nov. 14, 2006

(51) Int. Cl. G06F 17/00

(52) U.S. Cl. 715/267; 715/256; 715/255

(57) ABSTRACT

Calculations within a text editor may be provided. First, a text string may be received within the text editor. The received text string may be configured to be displayed on a display by the text editor. The text string may comprise information entered by a user into the text editor. The information may include equation text and language text associated with the equation text. Next, the text string may be parsed to detect an equation within the equation text in the text string. At least one calculation indicated by the detected equation may be performed to produce a result. The result may then be displayed.

### BACKGROUND

A text editor is a software application used to create and edit files. In some situations, a text editor may be used to record information such as notes taken in a class or business meeting. For example, a student may take notes during a class using a computer and text editing software. The notes taken by the student in the text editor may include an equation. In order to complete mathematical calculations within the equation, the student may choose to either use a handheld calculator, launch a calculator application on the computer, or launch a spreadsheet application on the computer. Once the student has performed the calculations outside the text editor, a result associated with the equation may be entered my the student into text editor. Thus, the conventional strategy is to go outside the text editor, complete the mathematical calculations within the equation, and enter a result into the text editor.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Calculations within a text editor may be provided. First, a text string may be received within the text editor. The received text string may be configured to be displayed on a display by the text editor. The text string may comprise information entered by a user into the text editor. The information may include equation text and language text associated with the equation text. Next, the text string may be parsed to detect an equation within the equation text in the text string. At least one calculation indicated by the detected equation may be performed to produce a result. The result may then be displayed.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIGS. 1A and 1B show example display output;

FIG. 2 is a flow chart of a method for providing calculations within a text editor;

FIG. 3 is screen shots illustrating a regional options dialog box; and

FIG. 4 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Calculations within a text editor may be provided. One problem with conventional systems is that solving a mathematical equation (e.g. determining a result), although easy for a computer, may be cumbersome for a user. In order to solve the equation (e.g. perform a calculation), the user, for example, may launch a calculator application or a spreadsheet application on the computer and enter the equation in order to obtain a result in conventional systems. Consistent with embodiments of the invention, however, the user may enter information (including the equation) via a text string into the text editor. Once the information is entered, the text editor may detect the equation within the text string, calculate the result, and display the result.

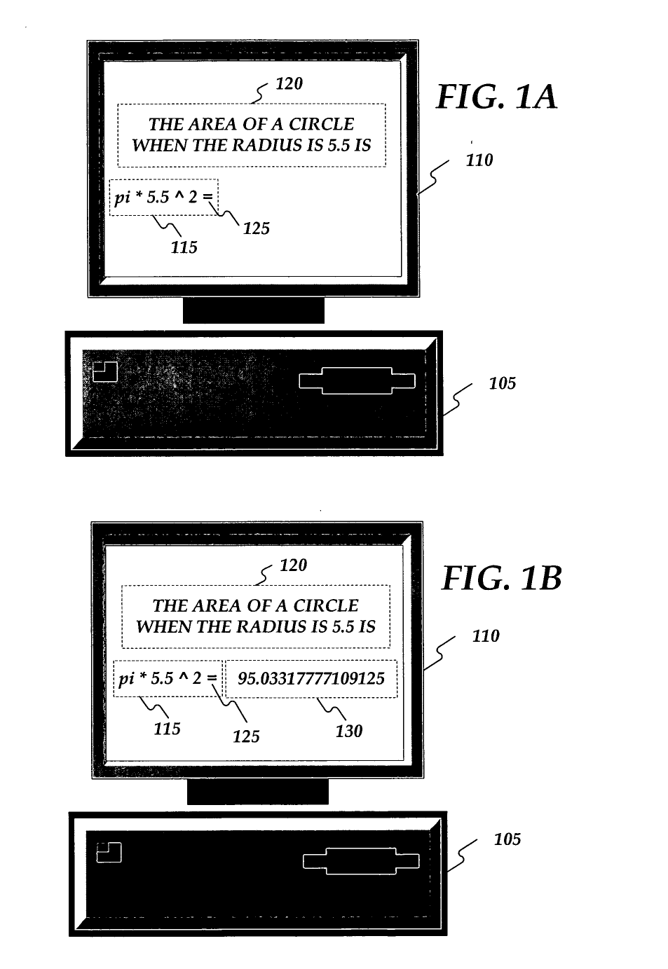

FIGS. 1A and 1B show example display output consistent with embodiments of the invention. For example, the user may comprise a student taking notes during a class. The user may enter information (e.g. the notes) into a text editor running on a computing device 105 having a display 110. The class discussion may include, for example, information regarding circle areas and may involve the following equation:

Pi*r̂2

The class' instructor may ask the class to calculate the area of a circle where r=5.5. Consistent with embodiments of the invention, the user may enter the information into the text editor. As shown in FIG. 1A and FIG. 1B, the entered information may include an equation text 115 and a language text 120 associated with equation text 115. In other words, the user may enter the below (e.g. equation text 115) equation into the text editor along with other notes (e.g. language text 120) taken during the class.

“pi*5.5̂2=”

The text editor may detect the above entered equation, produce a result 130, and display result 130. Consequently, the text editor may display on display 110 the following comprising the above mentioned equation text 115 and the above mentioned result 130 produced by the text editor:

“pi*5.5̂2=95.03317777109125”

### The text editor may display result 130 in response to the user entering a rendering symbol 125. Rendering symbol 125 may comprise, but is not limited to, an “=” sign.

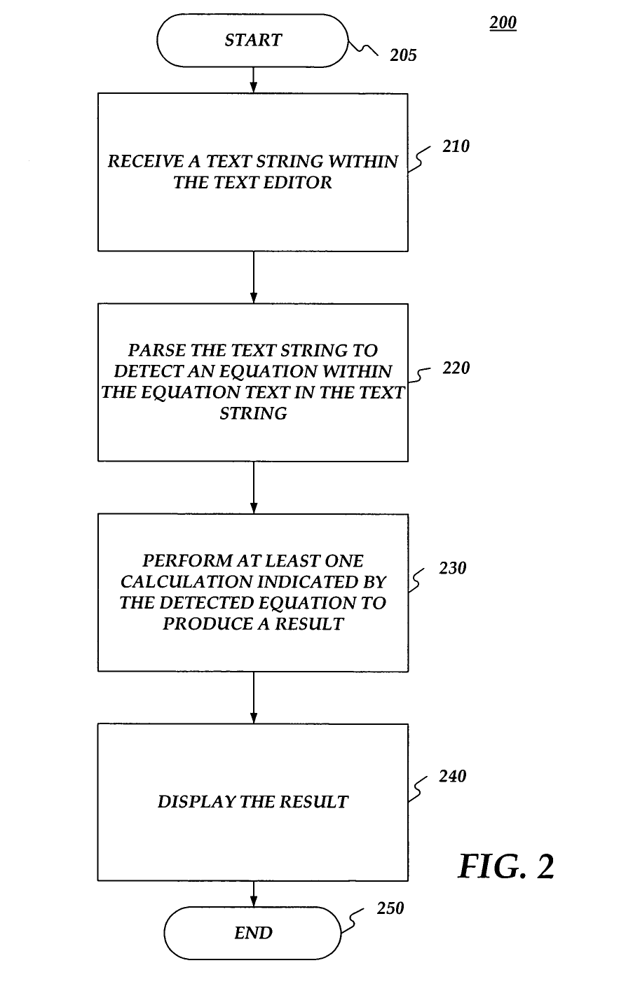

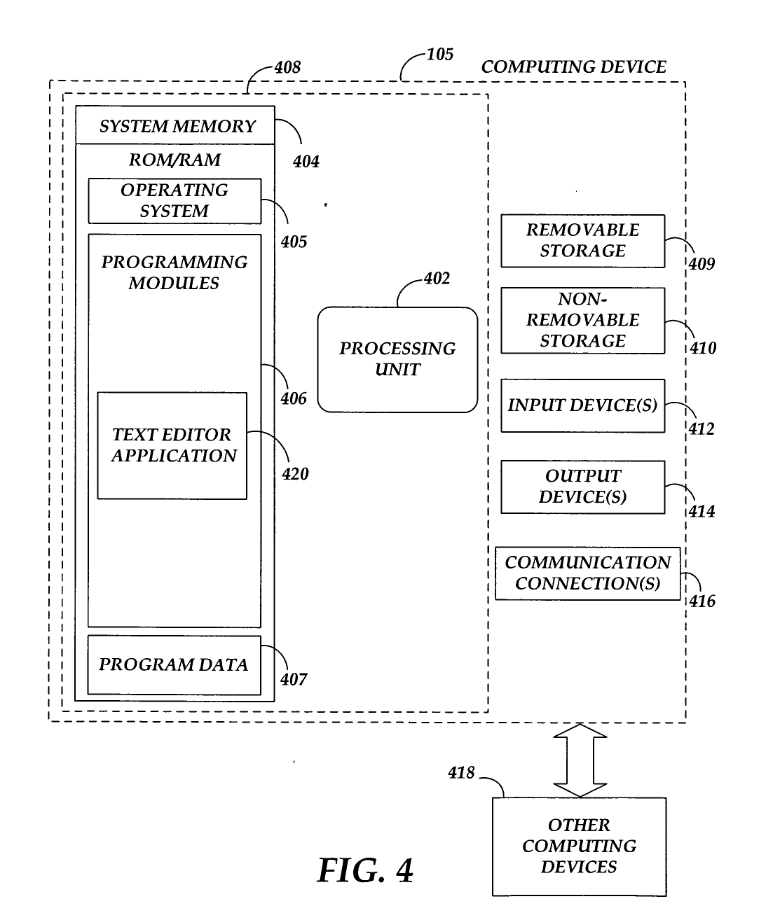

FIG. 2 is a flow chart setting forth the general stages involved in a method 200 consistent with an embodiment of the invention for providing calculations within a text editor. Method 200 may be implemented using computing device 105 as described above with respect to FIG. 1A and FIG. 1B and as described in more detail below with respect to FIG. 4. Ways to implement the stages of method 200 will be described in greater detail below.

Method 200 may begin at starting block 205 and proceed to stage 210 where computing device 105 may receive a text string within the text editor. The received text string may be configured to be displayed on display 110 by the text editor. The text string may comprise information entered by the user into the text editor. The text string may be displayed on display 110 as each symbol is received by the text editor. The information may include equation text 115 and language text 120 associated with equation text 115. For example, as described above with respect to FIG. 1A and FIG. 1B, the user may comprise a student taking notes during a math class. Using computing device 105, the user may enter information (e.g. the notes) into the text editor running on computing device 105. Though not so limited, the text editor may comprise or may be running within a note taking application. As described in more detail below with respect to FIG. 4, the text editor may comprise a text editor application 420. The class discussion may include, for example, information regarding circle areas or any other topic. The notes entered by the user into the text editor may include an equation, for example, for the area of a circle where the radius “r”=5.5. As shown in FIG. 1A, the entered information may include equation text 115 and language text 120 associated with equation text 115. In other words, the user may enter equation text 115 into the text editor along with other notes comprising language text 120.

The user may enter the text string into the text editor via a keyboard or mouse (e.g. an input device 412 as describe in more detail below with respect to FIG. 4). Consistent with other embodiments of the invention, the user may also “ink” the text string into the text editor. For example, computing device 105 may employ, for example, an electronic pen and tablet allowing the user to select and manipulate displayed text. In addition, this may allow the user to write electronically in a free-form fashion by touching the electronic pen to the table or to display 110. In this way the user can enter handwritten text as the text string. Consequently, the text editor may convert this inked input into a form usable by computing device 105.

From stage 210, where computing device 105 receives the text string, method 200 may advance to stage 220 where computing device 105 may parse the text string to detect an equation within equation text 115 in the text string. For example, the text editor may detect at least one symbol corresponding to an estimate of a transcendental number or at least one symbol corresponding to a non-transcendental number. For example, the text editor may recognize “pi” in any of the following forms: [symbol] , π, pi. In addition, “e” may be available as 2.71828183. The aforementioned are examples and other transcendental and non-transcendental number may be used and recognized by the text editor. In addition, the text editor may detect a mathematical operator such as “%”, “+”, “−”, “*”, and “/”. The aforementioned are examples and any mathematical operator may be recognized by the text editor. Moreover, the following functions may be recognized and used by the text editor: sqrt, sin, cos, tan, asin, acos, atan, degrees, radians, ln, log10 (or log), and mod. The aforementioned are examples and other functions may be recognized and used by the text editor.

Furthermore, when parsing the text string to detect the equation, the text editor may disregard at least one blank space (e.g. “white space”) in equation text 115. For example, white space up to 1024 spaces may be ignored. For example, if the user entered “5+3=”, the text editor may resolve this as a valid expression (in spite of the white spaces) and return a result.

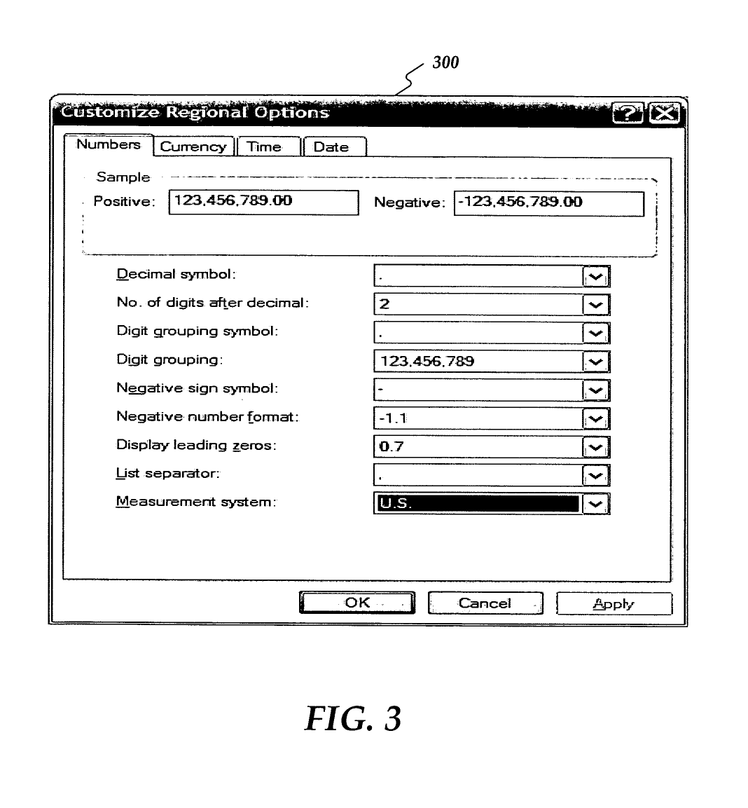

FIG. 3 is screen shots illustrating regional options dialog box 300. Because the text editor may be used in different countries and cultures having different mathematical customs, the user may establish the mathematical customs to be employed by the text editor. For example, the text editor may present regional options dialog box 300 to the user. Accordingly, the user may set the mathematical customs to be employed by the text editor. For example, the user may determine what symbol should be used as the decimal place (“.”, “,”, etc.) or the list separator (“.”, “, ”, etc.). As shown in FIG. 3. the user may also set the number of digits after the decimal, the digit grouping symbol, digit grouping, negative sign symbol, negative numeral format, whether to display leading zeros, or measurement system. The user can also set a currency system used (e.g. $, £, ¥, or ε).

Once computing device 105 parses the text string in stage 220, method 200 may continue to stage 230 where computing device 105 may perform at least one calculation indicated by the detected equation to produce result 130. For example, the text editor may parse the text string and detect equation text 115 comprising “pi*5.5̂2” as shown in FIG. 1 and FIG. 2. Consequently, the text editor may perform the calculation indicated by the detected equation text 115 to produce result 130 comprising “95.03317777109125”. When performing calculations, the text editor may perform operations in the following order: i) evaluate the expression within parentheses; ii) evaluate any exponents; iii) multiplication and division from left to right; and iv) addition and subtraction from left to right. When performing percentages, the text editor may take the following into consideration:
If two percentages together, then they cancel out:

45%/15%=3
If one percentage is present with multiplication or division, then evaluate by turning the percentage into normal decimal and compute:

x*15%=−−>(15/100*x)=so

200*15%=30
If one percentage is present with addition or subtraction, then that is an invalid expression and should not be evaluated:

100+15%=

The text editor may take computational failures into consideration. For example, if for any reason the text editor cannot calculate a result of a detected equation, the text editor may return no result. However, the text editor may detect that the user has made a minor error in entering an equation. Consequently, the text editor may return a result. For example, if the user entered: “((9*8)+7=”, the text editor may assume that the user forgot a parentheses and may still return a result reflecting this assumption. However, for more major errors, the text editor may return no result. For example, if the user entered “45/0=”, no result may be returned.

After computing device 105 performs the at least one calculation in stage 230, method 200 may proceed to stage 240 where computing device 105 may display result 130 on display 110 as shown in FIG. 1B. For example, once the calculation is performed, the text editor may wait until a rendering symbol is entered by the user. As shown in FIG. 1B, rendering symbol 125 may comprise an “=” character. The aforemetioned is an example, and the rendering symbol may comprise any symbol. Once rendering symbol 125 is detected, then the text editor may display result 130 on display 110. As shown in FIG. 1B, rendering symbol 125 may be displayed with result 130. However, the text editor may display result 130 without displaying rendering symbol 125.

Furthermore, the user may desire to have result 130 removed from display 110. For example, the user may wish to have equation text 115 entered into the text editor without result 130. Consequently, the text editor my employ an “undo” feature. For example, the text editor may display result 130 in a highlighted manner. The user may know that when a result is so displayed in such a highlighted manner, the user may imitate a certain input (e.g. the esc key, Ctrl-Z, back space, etc.) to cause the text editor to remove result 130. Once computing device 105 displays result 130 in stage 240, method 200 may then end at stage 250.

Embodiments consistent with the invention may comprise a system for providing calculations within a text editor. The system may comprise a memory storage and a processing unit coupled to the memory storage. The processing unit may be operative to receive a text string within the text editor. The received text string may be configured to be displayed on a display by the text editor. The text string may comprise information entered by a user into the text editor. The information may include equation text and language text associated with the equation text. In addition, the processing unit may be operative to parse the text string to detect an equation within the equation text in the text string. Moreover, the processing unit may be operative to perform at least one calculation indicated by the detected equation to produce a result and to display the result.

Other embodiments consistent with the invention may comprise a system for providing calculations within a text editor. The system may comprise a memory storage and a processing unit coupled to the memory storage. The processing unit may be operative to receive an inked input within the text editor. The received inked input may be configured to be displayed on a display by the text editor. The inked input may comprise information entered by a user into the text editor. The information may include an equation portion and a language portion associated with the equation text. In addition, the processing unit may be operative to detect an equation within the equation portion in the inked input. Moreover, the processing unit may be operative to perform at least one calculation indicated by the detected equation to produce a result and to display the result.

Yet other embodiments consistent with the invention may comprise a system for providing calculations within a text editor. The system may comprise a memory storage and a processing unit coupled to the memory storage. The processing unit may be operative to receive a first text string within the text editor. The received first text string may be configured to be displayed on a display by the text editor. In addition, the processing unit may be operative to display the first text string on the display and to detect an equation within the first text string. Moreover, the processing unit may be operative to perform at least one calculation indicated by the detected equation to produce a result. The processing unit may be additionally operative to receive a second text string within the text editor, the received second text string may be configured to be displayed on the display by the text editor and to detect a rendering symbol in the second text string. The result may be displayed by the processing unit in association with the displayed first text string on the display in response to the detected rendering symbol.

FIG. 4 is a block diagram of a system including computing device 105. Consistent with an embodiment of the invention, the aforementioned memory storage and processing unit may be implemented in a computing device, such as computing device 105 of FIG. 4. Any suitable combination of hardware, software, or firmware may be used to implement the memory storage and processing unit. For example, the memory storage and processing unit may be implemented with computing device 105 or any of other computing devices 418, in combination with computing device 105. The aforementioned system, device, and processors are examples and other systems, devices, and processors may comprise the aforementioned memory storage and processing unit, consistent with embodiments of the invention.

With reference to FIG. 4, a system consistent with embodiments of the invention may include a computing device, such as computing device 105. In a basic configuration, computing device 105 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may include a program data 407. Operating system 405, for example, may be suitable for controlling computing device 105's operation. In one embodiment, programming modules 406 may include, for example a text editor application 420. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 105 may have additional features or functionality. For example, computing device 105 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 105. Any such computer storage media may be part of computing device 105. Computing device 105 may also have input device(s) 412 such as a keyboard, a mouse, an electronic pen, an electronic tablet, a sound input device, a touch input device, electronic tablet, etc. Output device(s) 414 such as a display (e.g. display 110), speakers, a printer, etc. may also be included. The aforementioned devices are examples and others may be used.

Computing device 105 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 404, including operating system 405. While executing on processing unit 402, programming modules 406 (e.g. text editor application 420) may perform processes including, for example, one or more method 200's stages as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing calculations within a text editor, the method comprising:
receiving a text string within the text editor, the received text string being configured to be displayed on a display by the text editor, the text string comprising information entered by a user into the text editor, the information including equation text and language text associated with the equation text;
parsing the text string to detect an equation within the equation text in the text string;
performing at least one calculation indicated by the detected equation to produce a result; and
displaying the result.

2. The method of claim 1, wherein parsing the text string to detect the equation comprises:
detecting at least one of the following: at least one number, at least one symbol corresponding to an estimate of a transcendental number, and at least one symbol corresponding to a non-transcendental number; and
detecting at least one of the following: a mathematical operator and a mathematical function.

3. The method of claim 1, wherein parsing the text string to detect the equation comprises disregarding at least one blank space in the equation text.

4. The method of claim 1, further comprising detecting a rendering symbol in the equation text.

5. The method of claim 4, wherein detecting the rendering symbol in the equation text comprises detecting the rendering symbol comprising an “=” character.

6. The method of claim 4, wherein displaying the result comprises displaying the result in response to detecting the rendering symbol.

7. The method of claim 4, wherein displaying the result further comprises displaying the rendering symbol with the displayed result.

8. The method of claim 1, further comprising displaying on the display each character of the text string as each character of the text string is received.

9. The method of claim 1, further comprising:
receiving a user input indicating the user's preference to remove the result from the display; and
removing the result from the display in response to the received user input.

10. A system for providing calculations within a text editor, the system comprising:
a memory storage; and
a processing unit coupled to the memory storage, wherein the processing unit is operative to:
receive an inked input within the text editor, the received inked input being configured to be displayed on a display by the text editor, the inked input comprising information entered by a user into the text editor, the information including an equation portion and a language portion associated with the equation text;
detect an equation within the equation portion in the inked input;
perform at least one calculation indicated by the detected equation to produce a result; and
display the result.

11. The system of claim 10, wherein processing unit being operative to detect the equation comprises the processing unit being operative to:
detect at least one of the following: at least one number, at least one symbol corresponding to an estimate of a transcendental number, and at least one symbol corresponding to a non-transcendental number; and
detect at least one of the following: a mathematical operator and a mathematical function.

12. The system of claim 10, further comprising the processing unit being operative to detect a rendering symbol in the equation portion.

13. The system of claim 12, wherein processing unit being operative to display the result comprises the processing unit being operative to display the result in response to the detected rendering symbol.

14. The system of claim 10, further comprising the processing unit being operative to display on the display each character of the inked input as each character of the inked input is received.

15. The system of claim 10, further comprising processing unit being operative to:
receive a user input indicating the user's preference to remove the result from the display; and
remove the result from the display in response to the received user input.

16. A computer-readable medium which stores a set of instructions which when executed performs a method for providing calculations within a text editor, the method executed by the set of instructions comprising:
receiving a first text string within the text editor, the received first text string being configured to be displayed on a display by the text editor;
displaying the first text string on the display;
detecting an equation within the first text string;
performing at least one calculation indicated by the detected equation to produce a result;
receiving a second text string within the text editor, the received second text string being configured to be displayed on the display by the text editor;
detecting a rendering symbol in the second text string;
displaying the result in association with the displayed first text string on the display in response to the detected rendering symbol.

17. The computer-readable medium of claim 16, wherein receiving the first text string comprises receiving the first text string comprising information entered by a user into the text editor, the information including equation text and language text associated with the equation text.

18. The computer-readable medium of claim 16, wherein displaying the first text string on the display comprises displaying each character of the first string as each character in the first character string is received.

19. The computer-readable medium of claim 16, wherein detecting the rendering symbol in the second text string comprises detecting the rendering symbol comprising an “=” character.

20. The computer-readable medium of claim 16, wherein displaying the result further comprises displaying the rendering symbol.
